(19) United States
(12) Patent Application Publication
(10) Pub. No.: US 2006/0138938 A1
(43) Pub. Date: Jun. 29, 2006

(54) White LED utilizing organic dyes

(76) Inventors: Kheng Leng Tan, Penang (MY); Arosh Baroky Tajul, Penang (MY); Janet Bee Yin Chua, Penang (MY); Kok Chin Pan, Penang (MY); Kee Yean Ng, Pral (MY)

Correspondence Address: AVAGO TECHNOLOGIES, LTD., P.O. BOX 1920, DENVER, CO, 80201-1920, US

(21) Appl. No.: 11/025,450

(22) Filed: Dec. 27, 2004

(51) Int. Cl. H01J 1/62

(52) U.S. Cl. 313/503

(57) ABSTRACT

A light source having a light emitting semiconductor device on a die and a light conversion layer is disclosed. The die emits light of a first wavelength. The light conversion layer overlies the die and includes a first soluble fluorescent dye and a second fluorescent dye in a solid clear plastic carrier. The first and second florescent dyes convert the light entering the conversion layer to light of second and third wavelengths, respectively. At least one of the first and second dyes is excited by light of the first wavelength. In one embodiment, the second and third wavelengths are present in a ratio of intensities such that the light leaving the light conversion layer is perceived as white light by a human observer. The light conversion layer may be divided into sub-layers that include the individual dyes.

### BACKGROUND OF THE INVENTION

For the purposes of the present discussion, the present invention will be discussed in terms of a “white” light-emitting diode (LED); however, the methods and apparatus taught in the present invention can be applied to a wide range of LEDs. An LED that emits light that is perceived by a human observer to be “white” can be constructed by making an LED that emits a combination of blue and yellow light in the proper ratio of intensities. High intensity blue-emitting LEDs are known to the art. Yellow light can be generated from the blue light by converting some of the blue photons via an appropriate phosphor. In one design, a transparent layer containing dispersed particles of the phosphor covers an LED chip. The phosphor particles are dispersed in a potting material that surrounds the light-emitting surfaces of the blue LED. To obtain a white emitting LED, the thickness of the layer and uniformity of the dispersed phosphor particles must be tightly controlled.

Light sources based on dispersed phosphor particles have a number of problems. First, the light source is constructed by dispersing the particles in a liquid carrier that can be converted to a solid cap during a curing phase. The carrier is typically a transparent epoxy. The phosphor particles have densities that are significantly greater than that of the epoxy medium, and hence, tend to settle after mixing. Various solutions to the settling problem have been suggested. These solutions involve slowing the settling time by adding agents that increase the viscosity of the epoxy or reducing the time between the mixing of the particles with the epoxy and the time the epoxy is cured to a point at which settling is no longer a problem. While these solutions reduce the settling problems, these solutions also increase the cost and complexity of the fabrication operation.

Furthermore, the perceived color of the light can vary with the angle of viewing in light sources in which a portion of the blue light is converted to yellow. If a phosphor layer of uniform thickness is placed over the LED, light exiting the LED at different angles passes through different thickness of phosphor, and hence, the amount of blue light that is converted to yellow depends on the angle at which the light is emitted from the LED. As a result, the perceived color varies with the angle at which the light source is viewed. To reduce this effect, the thickness of the phosphor layer must be varied over the surface of the LED. Creating such a variable thickness layer in a low cost light source is difficult.

In addition, the phosphor particles scatter both the light generated by the LED and the light that has been converted by other phosphor particles. The phosphor particles are typically larger than the wavelength of the light being generated in the light source. In addition, the particles are either opaque or have an index of refraction that is substantially different from that of the surrounding epoxy medium. Hence, the particles scatter the light as well as convert light from one color to another. As a result of this scattering, the light source appears to be a broad diffuse source. Such sources present problems for optical systems that are needed to collimate or focus the light.

### SUMMARY OF THE INVENTION

The present invention includes a light source having a light emitting semiconductor die that generates light and a light conversion layer. The die emits light of a first wavelength. The light conversion layer overlies the die and includes a first soluble fluorescent dye and a second fluorescent dye in a solid clear plastic carrier. The first and second florescent dyes convert the light entering the conversion layer to light of second and third wavelengths, respectively. At least one of the first and second dyes is excited by light of the first wavelength. In one embodiment, the second and third wavelengths are present in a ratio of intensities such that the light leaving the light conversion layer is perceived as white light by a human observer. In one embodiment, the light conversion layer includes a first component layer in which the first soluble florescent dye is located and a second component layer in which the second soluble fluorescent dye is located. In one embodiment, the light conversion layer includes a pre-molded layer of the clear plastic carrier. In one embodiment, the first wavelength is in the UV portion of the optical spectrum. In one embodiment, the first wavelength is in the visible portion of the optical spectrum.

### BRIEF DESCRIPTION OF THE DRAWINGS

FIG. 1 is a cross-sectional view through a light source according to one embodiment of the present invention.

FIG. 2 is a cross-sectional view of a light source according to another embodiment of the present invention.

FIG. 3 is a cross-sectional view through a light source according to a third embodiment of the present invention.

### DETAILED DESCRIPTION OF THE PREFERRED EMBODIMENTS OF THE INVENTION

The present invention avoids the problems caused by the particulate nature of inorganic phosphors by utilizing soluble fluorescent dyes to provide the color conversion. Organic fluorescent dyes that can be excited by blue light in the 470 nm range are available from Lambda Physik, Inc. of Fort Lauderdale, Fla. For example, Coumarin 6 converts the blue light to green; Fluorol 7GA converts blue light to yellow green light; Rhodamine 110 converts blue light to yellow light, and Pyridine converts the blue light to red. Additional phosphors are available from Osram Sylvania, Inc., of Danvers, Mass. and from Molecular Probes Inc., Eugene Oreg.

The dyes can be used in multiple layers to provide a larger color shift than that available with a single dye. In such an arrangement, the color is shifted upwards at each layer by a small amount, and hence, even though the color-to-color shift of any one dye is small, the overall shift can be substantially larger.

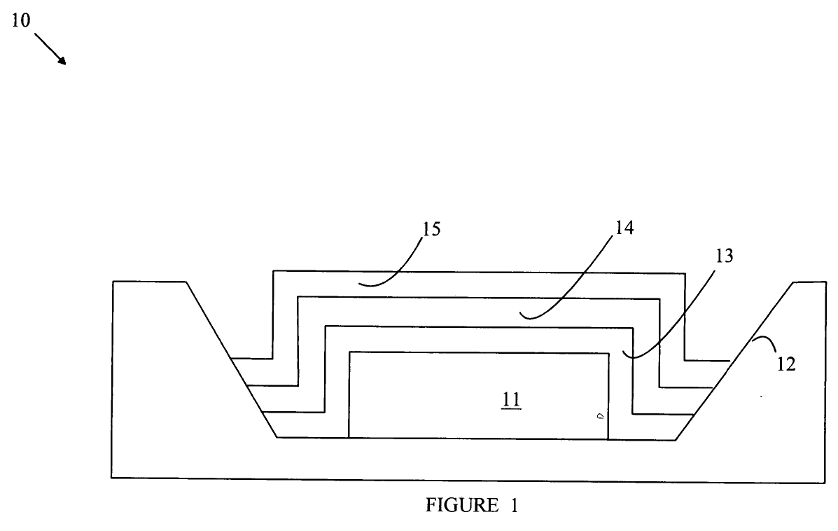

The dyes are soluble in a number of clear plastics, epoxies, and glass materials. Hence, the phosphor conversion layer can be provided by coating the die or by providing a pre-cast layer over the die. Refer now to FIG. 1, which is a cross-sectional view through a light source 10 according to one embodiment of the present invention. Light source 10 includes a light-emitting die 11 that is preferably an LED. Die 11 is mounted in a reflective cup 12 that directs light emitted from the sides of the die into the forward direction to increase the efficiency of light source 10. In this exemplary system, light source 10 includes three light conversion layers shown at 13-15. Each light conversion layer is constructed from a clear plastic having a soluble phosphor dissolved therein.

The light emitted from the die 11 can be in the UV range or visible range. This light can excite all of the phosphor layers directly. Alternatively, the phosphors can be chosen such that each layer is excited by the light emitted by the layer or layers between that layer and die 11. Furan or Stilbene converts UV to blue, Coumarin 152 converts UV to green and DCM, Phenoxazone 9 and Oxazine 4 convert UV to red. These dyes are sold by Lambda Physik.

Light source 10 is designed to provide a source of a particular perceived color, particularly white. In this case, the source can be constructed from two colors, blue and yellow. If the relative intensities are adjusted correctly, the source will appear to be white to the observer. In principle, a blue emitting LED can be used as the light source with a phosphor that converts some of the blue light to yellow. However, as the LED ages or changes temperature, the spectrum from the LED changes, and hence, a color shift will be perceived. In addition, the thickness problems discussed above cause a color shift with the angle of viewing. Accordingly, a light source having at least two dye layers in which each layer is excited to provide the two colors is preferred. In this case, a shift in the intensity or a small shift in the output spectrum will alter the intensity of the source as opposed to the color.

While a minimum of two colors are required to generate a light source that is perceived as being white, additional colors can be utilized. For example, a white source can be constructed by mixing light of three colors in the red, blue, and green regions of the spectrum.

The perceived color depends on the ratio of the light in each band that reaches the eye of the observer. The ratio of the various colors, in turn, depends on the thickness of the layers and the concentration of phosphor in each layer. The concentration of phosphor is easily controlled with a soluble dye, as there are no settling problems.

The thickness of the various layers can be controlled by the deposition scheme used to apply the carrier material containing the die. Screen printing methods can be used with epoxy-based materials, and spin-on-glass methods can be used with dyes that are dissolved in a glass. Since the thicknesses are more difficult to control if multiple layers are applied and then cured, embodiments that require only a single layer are preferred. If the various phosphors are excited directly by the light source on the die and only the converted light is to be viewed, a single layer in which the dyes are mixed in the correct ratios can be used to provide the correct color. In this case, variations in the thickness of the phosphor layer will only alter the intensity of the light generated as opposed to the color.

Consider the case in which the light source on the die emits light of a first wavelength that is then converted to a second wavelength by one layer, and light of the second wavelength is converted to a third wavelength. It will be assumed that the light from the die is completely converted, and hence, the observer perceives a color determined by the relative intensities of the light at the second and third wavelengths. In this case, a minimum of two layers must be utilized and the thicknesses of the layers must be carefully controlled.

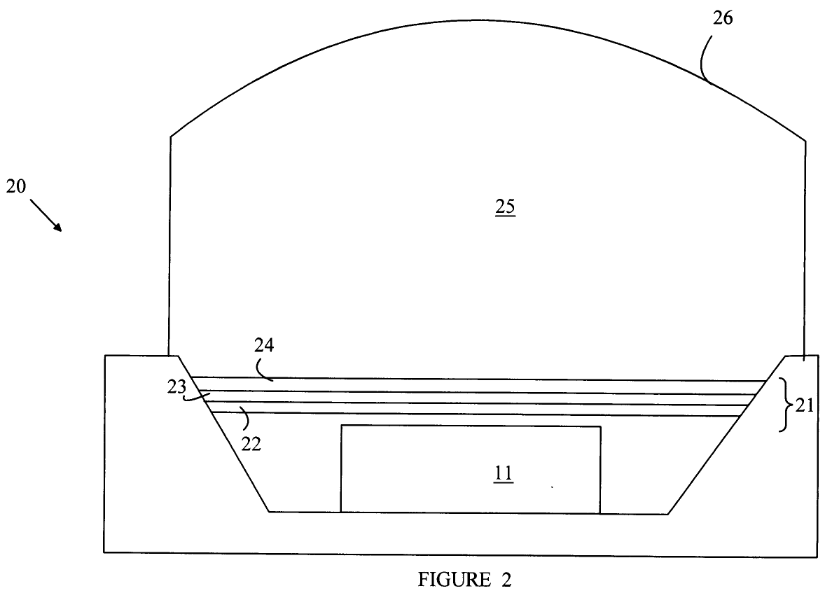

One method for controlling the relative thicknesses of the layer is to provide a pre-molded light conversion insert that is placed over the die during the packaging operation. Refer now to FIG. 2, which is a cross-sectional view of a light source 20 according to another embodiment of the present invention. Light source 20 utilizes a pre-molded conversion layer 21 having a plurality of component layers shown at 22-24. Each component layer includes a soluble phosphor that is dissolved in a clear plastic. The conversion layer can be fabricated by bonding the separate component layers prior to placing the layer above die 11. Alternatively, the various component layers can be placed over die 11 in the proper order. A clear plastic cap layer 25 that may include a lens 26 is then molded over light conversion layer 21 and holds the layer in place.

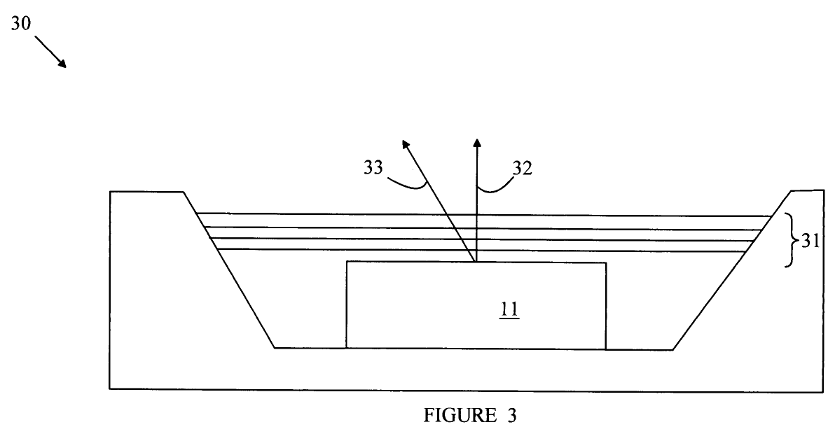

Another advantage inherent in a light source in which the light from die 11 is completely converted to the component colors viewed by the observer lies in the uniformity of color perceived by the observer as a function of viewing angle. Refer now to FIG. 3, which is a cross-sectional view through a light source 30 having a conversion layer 31. Light from die 11 is emitted in a range of angles relative to the surface of the die as shown at 32 and 33. The path length through the conversion layer depends on the angle at which the light is emitted. If the observed spectrum is the combination of the emitted light and the converted light, the ratio will change with the angle, as the path length through the conversion layer changes with the angle. Light emitted along path 33 will have a higher ratio of the conversion color to the native color of die than light emitted along path 32. If, on the other hand, all of the light viewed by the observer is generated in the conversion layer and its component layers, then the ratio of the color components will be more nearly constant since the relative path lengths along each direction remain constant. The percentage of the light that is converted depends on the thickness of each layer of dye on the die. The thickness typically varies from 10 μm to 100 μm, and the amount of light that is converted typically varies 10% to 90%. For example if Pyridine is used to convert blue light to red light a thickness that converts approximately 90% of the light is used. On the other hand, if magenta is to be the final conversion, the thickness will be considerably less.

Various modifications to the present invention will become apparent to those skilled in the art from the foregoing description and accompanying drawings. Accordingly, the present invention is to be limited solely by the scope of the following claims.

What is claimed is:

1. A light source comprising:
a die having a light-emitting semiconductor device that emits light of a first wavelength; and
a light conversion layer overlying said die, said light conversion layer comprising a first soluble fluorescent dye and a second soluble fluorescent dye in a solid clear plastic carrier, said first and second florescent dyes converting light into a second and a third wavelength, respectively, at least one of said first and second dyes being excited by light of said first wavelength.

2. The light source of claim 1 wherein said second and third wavelengths are present in a ratio of intensities such that said light leaving said light conversion layer is perceived as white light by a human observer.

3. The light source of claim 1 wherein said light conversion layer comprises a first component layer in which said first soluble florescent dye is located and a second component layer in which said second soluble fluorescent dye is located.

4. The light source of claim 1 wherein said light conversion layer comprises a pre-molded layer of said clear plastic carrier.

5. The light source of claim 1 wherein said first wavelength is in the UV portion of the optical spectrum.

6. The light source of claim 1 wherein said first wavelength is in the visible portion of said optical spectrum.

7. The light source of claim 1 wherein said light conversion layer converts more than 10 percent of said light of said first wavelength entering said light conversion layer to either said second or said third wavelength.
